(19) United States
(12) Patent Application Publication
(10) Pub. No.: US 2018/0306630 A1
(43) Pub. Date: Oct. 25, 2018

(54) MOLDED SIGHT TUBE FOR FLUID LEVEL VERIFICATION APPARATUS

(71) Applicant: Oil-Rite Corporation, Manitowoc, WI (US)

(72) Inventors: Carolyn M. Boldt, Manitowoc, WI (US); Michael J. Wech, Manitowoc, WI (US)

(73) Assignee: Oil-Rite Corporation, Manitowoc, WI (US)

(21) Appl. No.: 16/022,229

(22) Filed: Jun. 28, 2018

Related U.S. Application Data
(63) Continuation-in-part of application No. 14/754,191, filed on Jun. 29, 2015.

(51) Int. Cl. G01F 23/02; F22B 37/78

(52) U.S. Cl. CPC G01F 23/02; F22B 37/78

(57) ABSTRACT

A method for molding an improved sight tube for fluid level related applications comprising molding annular grooves a predetermined distance from respective sight tube ends, a conduit substantially traveling about central axis, along the length of the sight tube, with substantially constant or varying diameter, and a second embodiment of the invention comprising molding secondary annular grooves in addition to the above described features, to reduce the potential for leakage between a fluid level verification apparatus end pieces and the sight tube and to reduce material and manufacturing costs for manufacturing the sight tubes.

### RELATED APPLICATION

This application is a continuation-in-part of co-pending U.S. patent application. Ser. No. 14/754,191, filed 29 Jun. 2015.

### BACKGROUND OF THE INVENTION

The present invention relates generally to a fluid level verification apparatus which is operable to measure the amount of fluid present in an object of interest, such as a tank, machine, or other article of manufacture, and more specifically, to a sight tube utilized in the fluid level verification apparatus which may be manufactured using a molding process.

Sight tubes are a component of a fluid level verification apparatus and known in the art for indicating fluid levels in the vessel to which the apparatus is attached. Prior art fluid verification devices have typically included a transparent tube or inspection window, which is connected in particular relation to the holding tank, and which provides a quick and convenient means by which an observer may visually verify the level of the fluid present.

Sight tubes are typically formed by cutting an elongated tube into a predetermined length. Molding of sight tubes is known in art. In the prior art, the elongated tube is formed by an extrusion process. However, the extrusion process produces draw lines in the elongated tube due to wear in the extrusion die as a result of use. Additionally, the extrusion process produces air bubbles in the elongated tube. Further, the wall thickness of the extruded elongated tube will varying based upon the stock material used. Prior art processes use nylon to produce sight tubes. When manufacturing nylon sight tubes, environmental factors influence the quality of the sight tube produced. High humidity environments will cause dimensions of the sight tube to increase, while low humidity environments will cause the opposite to occur. The nylon sight tubes can be annealed to prevent swelling. However, the annealing process is lengthy and expensive. Further, the annealing process is not an exact science.

Further, nylon sight tubes possess a yellow tint which is undesirable in many applications. Additionally, prior art applications of Trogamid® have a yellow color when processed and are subject to hazing.

As a next stage in the prior art manufacturing process, grooves are formed in the sight tube near its opposed ends. The grooves are formed through a machining process. Machining of grooves in the sight tube near its opposed ends produces high stress within the sight tube, especially at the sharp corners formed by the groove cutting process. This process lends itself to “crazing” (microscopic cracks), extra machining, and the potential for design failure.

Molding of sight tubes containing annular grooves is not known in the art. The prior art requires o-rings or seals to rest against the surfaces of the inspection window and not in an annular grooves. Another prior art reference requires the sight tube end to compressively communicate with art o-ring or seal. However, the prior art confronts a perennial issue, eventual leakage between a fluid level verification apparatus and a sight tube due to environmental conditions. Vibrations and temperature changes eventually cause the sealing action between the fluid level verification apparatus and the sight tube to be compromised.

A need exists for a process for manufacturing a molded sight tube containing at least one annular groove proximate to the ends of the sight tube for effective long-term sealing between a fluid level verification apparatus and sight tube.

A need exists for a process for manufacturing a molded sight tube containing at least one annular groove proximate to the ends of the sight tube where the sight tube does not possess the high stresses resulting from machining of grooves in the sight tube.

A need exists for a process for manufacturing a molded sight tube ready for use after the molding process. As opposed to cutting the sight tube to length and cutting the required grooves, the present invention contemplates molding the sight tube to the desired length and with the grooves in a single operation.

A need exists for a process for manufacturing a molded sight tube having consistent wall thickness or inconsistent (varying) wall thickness.

A need exists for a process for manufacturing a molded sight tube having improved clarity.

A need exists for a process for manufacturing a molded sight tube which reduces the environmental effects of humidity upon the sight tube.

### SUMMARY OF THE INVENTION

An objective of this invention is to provide a process for molding a sight tube for fluid level related applications not requiring machining to produce a conduit having a predetermined length, at least one annular groove and at least one secondary annular groove.

Another objective of this invention is to provide a process for molding the sight tube for fluid level not requiring any machining operations to produce the desired length, conduit geometry and at least one annular groove. Another objective is to provide a process for molding the sight tube for fluid level requiring minimal machining operations to produce the desired length, conduit geometry and at least one annular groove. Another objective is to provide a process for molding the sight tube which reduces the environmental effects of humidity on the sight tube, such as injection molding.

In one embodiment of the invention, a method involves preparing a mold form for the sight tube. The method may also involve molding a sight tube comprising: a first sight tube end; a second sight tube end; the first sight tube end and the second sight tube end being oppositely disposed, separated by the length of a tubular section, the sight tube length; the sight tube having an outer periphery, and at least one annular groove molded in the outer periphery inwardly spaced from at least one of the first sight tube end and the second sight tube end.

The process may preferably comprise molding a sight tube possessing a length defining the tubular section, the sight tube length. The process may preferably comprise molding a sight tube possessing a conduit having a conduit diameter which may preferably travel the length of the sight tube, about a central axis of the sight tube. The process may preferably comprise molding a sight tube where the conduit diameter may preferably be substantially constant over the length. Alternatively, the process may comprise molding a sight tube where the conduit diameter may vary over the length. The process may preferably comprise molding a sight tube where an at least one indicia may be provided on the sight tube for indicating fluid level. A seal may be disposed within each of the at least one annular groove in the periphery of the sight tube.

In another embodiment of the invention, the method involves preparing a mold form for the sight tube. The method involves molding the sight tube comprising: preparing the mold form for the sight tube. Additionally, the method of molding the sight tube involves molding the sight tube comprising: the first sight tube end; the second sight tube end; the first sight tube end and the second sight tube end being oppositely disposed, separated by the length of the tubular section; and the sight tube having an outer periphery, and the at least one annular groove molded in the outer periphery inwardly spaced from each of the first sight tube end and the second sight tube end. The process may comprise molding the sight tube where an at least one, preferably two, secondary annular grooves are molded in the outer periphery inwardly spaced from each of the first sight tube end and the second sight tube end.

The process may preferably comprise molding the sight tube where the sight tube possesses a length defining the tubular section, the sight tube length. The process may preferably comprise molding a sight tube possessing a conduit having a conduit diameter which may preferably travel the length of the sight tube, about a central axis of the sight tube. The process may preferably comprise molding the sight tube where the conduit diameter may be substantially constant over the length. Alternatively, the process may comprise molding the sight tube where the conduit diameter may vary over the length. The process may preferably comprise molding at least one, preferably two, secondary annular grooves inwardly spaced from said at least one, preferably two, annular grooves. The at least one, preferably two, secondary annular grooves may section a middle section into substantially equal lengths providing for high and low fluid level indications. The process may comprise providing the at least one indicia on the sight tube. A seal may be disposed within each of the at least one annular groove in the periphery of the sight tube.

The process employs polymers known in the art. Preferably the process may employ Trogamid®, a crystallizable and permanently transparent polyamide. Further, injection molded Trogamid® is clear. Alternative and not exclusively, the process may employ acrylic or polycarbonate.

An intended benefit of the invention is a significant reduction in stresses within the sight tube by eliminating the machining process for creation of the at least one annular groove and the at least one secondary annular groove.

An intended benefit of the invention the sight tube is ready for use after the molding process requiring no machining of sight tube dimensions.

An intended benefit of the invention in manufacturing of the at least one annular groove for the o-rings or seals having reduced stress as compared to grooves produced with prior art manufacturing processes, and the improved geometrical tolerances for the at least one annular groove provide for an exact fit for each seal or o-ring or seal.

An intended benefit of the invention is the manufacturing of sight tubes having vastly improved clarity.

An intended benefit of the invention is a significant cost savings due to reduced manufacturing costs and reduced material costs.

An intended benefit of the invention is the manufacturing of sight tubes with reduced long-term drainage between the fluid level verification apparatus and the sight tube.

An intended benefit of the invention is the manufacturing of a molded sight tube which reduces the environmental effects of humidity upon the sight tube.

### BRIEF DESCRIPTION OF THE DRAWINGS

FIG. 1 is a perspective view of a sight tube manufactured by a first embodiment of the present invention.

FIG. 2 is an end view of the sight tube manufactured by the present invention.

FIG. 3 is a sectional view of the sight tube and an o-ring, taken along line 3-3 of FIG. 1, manufactured by the first embodiment of the present invention and illustrating a conduit having a substantially constant diameter over a length.

FIG. 4 is the sectional view of the sight tube, taken along line 3-3 of FIG. 1, manufactured by the first embodiment of the present invention and illustrating the conduit having a varying diameter over the length.

FIG. 5 is a perspective view a sight tube manufactured by a second embodiment of the present invention.

FIG. 6 is a sectional view of the sight tube, taken along line. 6-6 of FIG. 5, manufactured by the second embodiment of the present invention and illustrating a conduit having a substantially constant diameter over a length.

### DESCRIPTION OF THE PREFERRED EMBODIMENT

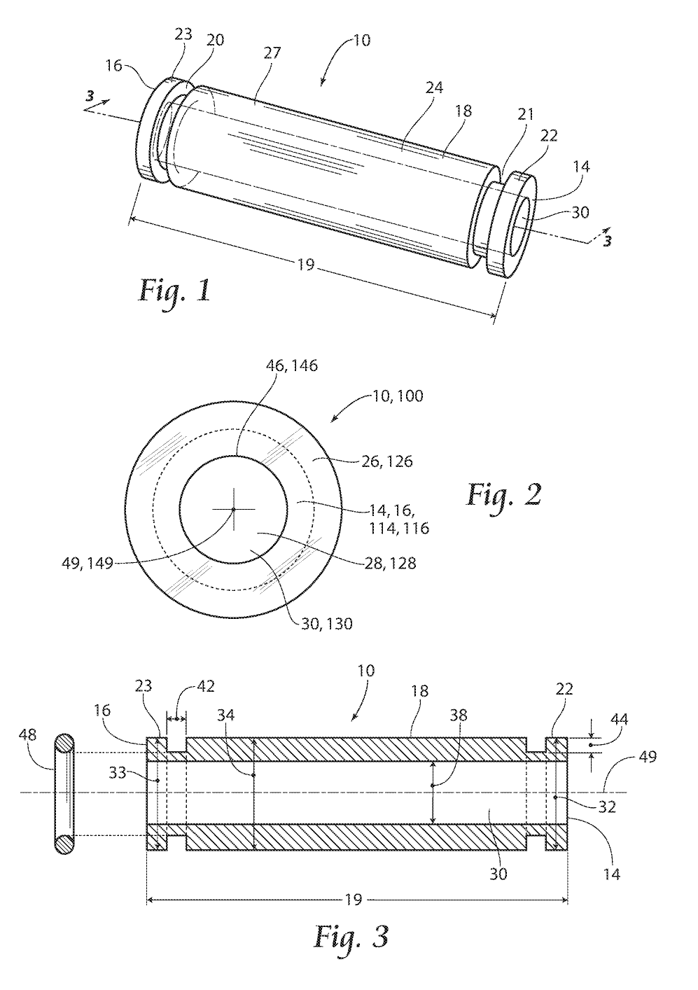

With attention to FIG. 1, a sight tube manufactured by a first embodiment of the present invention, and FIG. 5, a sight tube manufactured by a second embodiment of the present invention, a process for molding the sight, tube (10, 100) is described. The first embodiment involves molding the sight tube 10. The second embodiment involves molding the sight tube 100. Molding of the sight tube (10, 100) results in an intended benefit of the invention being a significant reduction in stresses within the sight tube by eliminating the machining process for creation of an at least one annular groove (20, 21, 120, 121). Additionally, molding of the sight tube (10, 100) results in an intended benefit of the invention which is the sight tube is ready for use after the molding process requiring no machining of the sight tube dimensions. Further, molding of the sight, tube (10, 100) results in an intended benefit, of the invention which is a significant cost savings due to reduced manufacturing costs and reduced material costs. Injection molding the sight tube (10, 100) reduces the environmental effects of humidity on the sight tube (10, 100). Thus, an intended benefit of the invention is the manufacturing of a sight tube (10, 100) which reduces the environmental effects of humidity upon the sight tube.

With respect to FIG. 1, the first embodiment of the process molds the sight tube 10 such that the sight tube 10 is preferably translucent and more preferably clear. Injection molded Trogamid® is clear. The first embodiment of the process molds the sight tube 10 having a first, sight tube end 14, a second sight tube end 16, and a tubular section 27. The first embodiment of the process molds the first sight tube end 14 oppositely disposed to the second sight tube end 16 and separated by a length 19 of the tubular section 27, which is the length 19 of the sight tube 10, between the first sight tube end 14 and the second sight tube end 16. The first embodiment of the process molds the sight tube 10 having an outer periphery 24 of the tubular section 27. The first embodiment of the process molds at least one, preferably two, annular grooves (20, 21) in the outer periphery 24 inwardly spaced from each of the first sight tube end 14 and the second sight tube end 16, positioned at a predetermined distance from the respective sight tube ends 14, 16. The first embodiment of the process molds at least one annular groove (20, 21) preferably proximate to each of the first sight tube end 14 and the second sight tube end 16. Alternatively, the first embodiment of the process molds the at least one annular groove (20, 21) proximate to one of the first sight tube end 14 or the second sight tube end 16. Application of preferably two annular groove (20, 21) molds the sight tube 10 into a first outer section 22, a middle section 18, and a second outer section 23.

Alternatively, the first embodiment of the process molds an (n) number of annular grooves (20, 21), where n is equivalent to any integer, segmenting the sight tube 10 into (n+1) number of sections. The first embodiment of the process molds the at least one annular groove (20, 21) in the outer periphery 24 in the sight tube 10. Further, the first embodiment of the process molds the sight tube 10 possessing a conduit 30 traveling the length 19 of the sight tube 10 about a central axis 49 of the length 19. Alternatively, the first embodiment of the process molds the sight tube 10 such that the conduit 30, traveling a length 19 of the sight tube 10, may not be traveling about the central axis 49 of the length 19.

With respect to FIG. 2, an end view of the sight tube (10, 100) manufactured by the present invention, the process molds the sight tube ends (14, 16, 114, 116) each comprising a conduit opening (28, 128) and a border (26, 126). The border (26, 126) preferably surrounds the conduit opening perimeter (46, 146) and defines the conduit opening (28, 128).

With respect to FIG. 3, a sectional view of the sight tube, taken along line 3-3 of FIG. 1, manufactured by the first embodiment of the present invention and illustrating a conduit having a substantially constant diameter over a length, the first embodiment of the process molds the sight tube 10 having the length 19 and the conduit 30 extending the length 19 of the sight tube 10. As disclosed, the first embodiment of the process molds preferably two annular grooves (20, 21) segmenting the sight tube 10 into a first outer section 22, a middle section 18, and a second outer section 23. The first embodiment of the process molds the first outer section 22 possessing a first outer section outer diameter 32. The first embodiment of the process molds the second outer section 23 possessing a second outer section outer diameter 33. The first embodiment of the process molds the middle section 18 possessing a middle section outer diameter 34. Preferably, the first embodiment of the process molds the first outer section outer diameter 32, the second outer section outer diameter 33, and the middle section outer diameter 34 equivalent or nearly equivalent. Alternatively, the first embodiment of the process molds the sight tube 10 such that at least one of the first outer section outer diameter 32, the second outer section outer diameter 33, and the middle section outer diameter 34 may be disparate from the remainder.

Alternatively, the first embodiment of the process molds the sight tube 10 with (n) number of the annular groove (20, 21), where n is equivalent to any integer, segmenting the sight tube 10 into (n+1) number of sections. The first embodiment of the process molds the sight tube 10 such that each of the (n+1) number of sections possessing an outer diameter. Preferably, each of the (n+1) number of outer section diameters are equivalent or nearly equivalent. Alternatively, one or a combination of the (n+1) number of outer section diameters may be disparate from the remainder. The first embodiment of the process molds the sight tube 10 such that the at least one annular groove (20, 21) each have a respective groove width 42 and groove depth 44. The first embodiment of the process molds the sight tube 10 such that the respective groove depths 44 are selected to accommodate a first seal, such as an o-ring or seal 48. It is preferable that the groove depth 44 is greater than half the o-ring or seal thickness (not illustrated in the figures). The process of molding the groove depths 44 results in an intended benefit of the invention in manufacturing of the at least one annular groove (20, 21) for the o-rings or seals 48 having reduced stress as compared to grooves produced with prior art manufacturing processes, and the improved geometrical tolerances for the at least one annular groove (20, 21) provide for an exact fit for each o-ring or seal 48. Additionally, the molding of the at least one annular groove (20, 21) results in an intended benefit of the invention which is the molding of sight tubes 10 with reduced long-term drainage between the fluid level verification apparatus (not illustrated in the figures) and the sight tube 10.

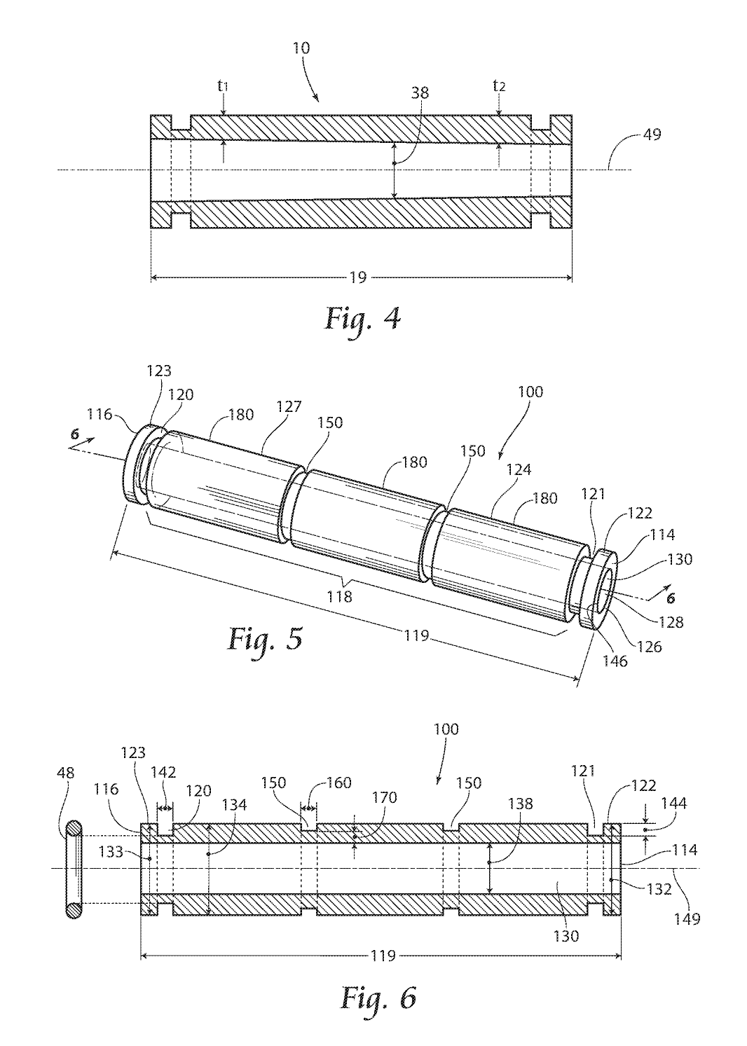

With respect to FIG. 3, the sectional view of the sight tube, taken along line 3-3 of FIG. 1, manufactured by the first, embodiment of the present invention and illustrating a conduit having a substantially constant diameter over a length, and FIG. 4, the sectional view of the sight tube, taken along line 3-3 of FIG. 1, manufactured by the first embodiment of the present invention and illustrating the conduit having a varying diameter over the length (see FIG. 4 where t1<t2), the first embodiment of the process molds the sight tube 10 such that the conduit 30 possesses a conduit diameter 38 over the length 19 of the sight tube 10. The first embodiment of the process molds the sight tube 10 such that the conduit diameter 38 may preferably substantially constant over the length 19. Alternatively, the first embodiment of the process molds the sight tube 10 such that the conduit diameter may vary over its length 19.

The first embodiment of the process molds the sight tube 10 such that indicia (not illustrated in FIG. 1) may be provided on the sight tube 10. The first embodiment of the process molds the sight tube 10 such that indicia (not illustrated in FIG. 1) may be provided on the sight tube 10 using a method known in the art other than molding. The indicia (not illustrated in the figures) may include, but not be limited to, high and/or low level markings, text, gradients, hash marks, etc.

Preferably, the first embodiment of the process molds the sight tube 10 employing Trogamid®, a crystallizable and permanently transparent polyamide. As previously noted, injection molded Trogamid® is clear. Alternative and not exclusively, the first embodiment of the process may mold the sight tube 10 employing acrylic or polycarbonate. Alternatively, the first embodiment of the process may mold the sight tube 10 employing at least one of various substrates known the art which are amendable to a molding process. While shown to be cylindrical in shape, it is conceivable that other conduit cross-sectional configurations could be utilized. An intended benefit of the invention is the manufacturing of sight tubes having vastly improved clarity.

With attention to FIG. 5, a sight tube manufactured by a second embodiment of the present invention, and FIG. 6, a sectional view of the sight tube, taken along line 4-4 of FIG. 5, manufactured by the second embodiment of the present invention and illustrating a conduit having a substantially constant diameter over a length, the second embodiment of the process involves preparing a mold form for the sight tube. The second embodiment of the process involves molding the sight tube 100. The second embodiment of the process molds the sight tube 100 such that the sight tube. 100 is preferably translucent and more preferably clear. Injection molded Trogamid® is clear. The second embodiment of the process molds the sight tube 100 having a first sight tube end 114, a second sight tube end 116, and a tubular section 127. The second embodiment of the process molds the sight tube 100 with the first sight tube end 114 oppositely disposed to the second sight tube end 116 and separated by a length 119 of the tubular section 127, which is the length 119 of the sight tube 100, between the first sight tube end 114 and the second sight tube end 116. The second embodiment of the process molds the sight tube 100 having an outer periphery 124 of the tubular section 127. The second embodiment of the process molds the sight tube 100 such that at least one, preferably two, annular grooves (120, 121) are molded in the outer periphery 124 inwardly spaced from each of the first sight tube end 114 and the second sight tube end 116, positioned at a predetermined distance from the respective sight tube ends 114, 116. The second embodiment of the process molds the sight tube 100 such that at least, one annular groove (120, 121) is preferably proximate to each of the first sight tube end 114 and the second sight tube end 116. Alternatively, the second embodiment of the process molds the sight tube 100 such that at least one annular groove (120, 121) is proximate to one of the first sight tube end 114 or the second sight tube end 116. The second embodiment of the process molds the sight tube 100 with application of preferably two annular grooves (120, 121) segmenting the sight tube 100 into a first outer section 122, a middle section 118, and a second outer section 123.

Alternatively, the second embodiment of the process molds the sight tube 100 applying an (n) number of annular grooves (120, 121), where a is equivalent to any integer, which segment the sight tube 100 into (n+1) number of sections. The second embodiment of the process molds the sight tube 100 molding the at least one, preferably two, annular grooves (120, 121) in the outer periphery 124 of the sight tube 100. Further, the second embodiment of the process molds the sight tube 100 possessing a conduit 130 traveling a length 119 of the sight tube 100 about a central axis 149 of the length 119. Alternatively, the second embodiment of the process molds the sight tube 100 such that the conduit 130, traveling a length 119 of the sight tube 100, may not be traveling about the central axis 149 of the length 119.

The second embodiment of the process molds the sight tube 100 such that the sight tube ends 114, 116 each comprise a conduit opening 128 and a boarder 126. The second embodiment of the process molds the sight tube 100 such that the border 126 preferably surrounds the conduit opening perimeter 146 and defines the conduit opening 128.

The second embodiment of the process molds the at least one, preferably two, annular grooves (120, 121) into the sight tube 100 such that the at least one, preferably two, annular groove (120, 121) segments the sight tube 100 into a first outer section 122, a middle section 118, and a second outer section 123. The second embodiment of the process molds the sight tube 100 such that the first outer section 122 possesses a first outer section outer diameter 132. The second embodiment of the process molds the sight tube 100 such that the second outer section 123 possesses a second outer section outer diameter 133. The second embodiment of the process molds the sight tube 100 such that the middle section 118 possesses a middle section outer diameter 134.

The second embodiment of the process molds the sight tube 100 such that the sight tube 100 possesses at least one, preferably two, secondary annular grooves 150 provided in the outer periphery 124 inwardly spaced from each of the first sight tube end 114 and the second sight tube end 116, and preferably inwardly spaced from at least one annular groove (120, 121) and sectioning the middle section 118 into substantially equal lengths.

The second embodiment of the process molds the at least one, preferably two, annular grooves (120, 121), such the at least one, preferably two, secondary annular grooves 150 section the middle section 118 into subsections 180 of equal or nearly equal lengths. Alternatively, the second embodiment of the process molds the at least one, preferably two, annular grooves (120, 121), such the at least one, preferably two, secondary annular grooves 150 section the middle section 118 into subsections 180 which are of less than substantially equal length. The second embodiment of the process molds the sight tube 100 such that the middle section outer diameter 134 may vary between subsections 180. In the alternative, the second embodiment of the process molds the sight tube 100 such that the sections on which the at least one, preferably two, secondary annular groove 150 is applied are divided into subsections 180 of equal or nearly equal lengths. Alternatively, the second embodiment of the process molds the sight tube 100 such that the outer diameters of the subsections 180 may vary between subsections 180.

The second embodiment of the process molds the sight tube 100 such that the first outer section outer diameter 132, second outer section outer diameter 133, and middle section outer diameter 134 are equivalent or nearly equivalent. Alternatively, the second embodiment of the process molds the sight tube 100 such that at least one of the first outer section outer diameter 132, second outer section outer diameter 133, and middle section outer diameter 134 may be disparate or dissimilar from the remainder.

Alternatively, the second embodiment of the process molds the sight tube 100 having an (n) number of annular grooves (120, 121), where n is equivalent to any integer, segmenting the sight tube 100 into (n+1) number of sections. The second embodiment of the process molds the sight tube 100 such that each of the (n+1) number of sections possesses an outer diameter. Preferably, the second embodiment of the process molds the sight tube 100 such that each of the (n+1) number of outer section diameters are equivalent or nearly equivalent. Alternatively, the second embodiment of the process molds the sight tube 100 such that one or a combination of the (n+1) number of outer section diameters may be disparate or dissimilar from the remainder.

The second embodiment of the process molds the sight tube 100 such that the at least one, preferably two, annular grooves (120, 121) each have a respective groove width 142 and groove depth 144. The second embodiment of the process molds the sight tube 100 such that the respective groove depths 144 are selected to accommodate a first seal, such as an o-ring or seal 48. It is preferable that the second embodiment of the process molds the sight tube 100 such that the groove depth 144 is greater than one half the o-ring or seal thickness (not illustrated in the figures). The second embodiment of the process molds the sight tube 100 such that the at least one, preferably two, secondary annular groove 150 each have a respective groove width 160 and groove depth 170.

The process molding the groove depths 144 results in an intended benefit of the invention in manufacturing of the at least one, preferably two, annular grooves (120, 121) for the o-rings or seals 48 having reduced stress as compared to grooves produced with prior art manufacturing processes, and the improved geometrical tolerances for the at least one, preferably two, annular grooves (120, 121) provide for an exact fit for each o-ring or seal 48. Additionally, the molding of the at least one, preferably two, annular grooves (120, 121) results in an intended benefit of the invention which is the molding of sight tubes 100 with reduced potential for leakage between the fluid level verification apparatus end pieces (not illustrated in the figures) and the sight tube 100.

The second embodiment of the process molds the sight tube 100 such that the conduit 130 possesses a conduit diameter 138 over the length 119 of the sight tube 100. The second embodiment of the process molds the sight tube 100 such that the conduit diameter 138 may preferably be substantially constant over the length 119. Alternatively, the second embodiment of the process molds the sight tube 100 such that the conduit diameter may vary over the length 119.

The second embodiment of the process molds the sight tube 100 such that additional indicia (not illustrated in the figures) may be provider on the sight tube 100. The first embodiment of the process molds the sight tube 100 such that indicia (not illustrated in the figures) may be provided on the sight tube 100 using a method known in the art other than molding. The indicia (not illustrated in the figures) may include, but not be limited to, high and/or low level markings, text, gradients, hash marks, etc.

Preferably, the second embodiment of the process molds the sight tube 100 employing Trogamid, a crystallizable and permanently transparent polyamide. As previously noted, injection molded Trogamid® is clear. Alternative and not exclusively, the second embodiment of the process may mold the sight tube 100 employing acrylic or polycarbonate. Alternatively, the second embodiment of the process may mold the sight tube 100 employing at least one of various substrates known in the art which are amendable to a molding process. While shown to be cylindrical in shape, it is conceivable that other conduit cross-sectional configurations could be utilized. An intended benefit of the invention is the manufacturing of sight tubes having vastly improved clarity.

Although the disclosure hereof is detailed and exact to enable those skilled in the art to practice the invention, the physical embodiments herein disclosed merely exemplify the invention which may be embodied in other specific structures and methods. While the preferred embodiment has been described, the details may be changed without departing from the invention, which is defined by the claims.

We claim:

1. A method of molding a sight tube comprising:
preparing a mold form for the sight tube;
molding the sight tube comprising:
a first sight tube end;
a second sight tube end;
the first sight tube end and the second sight tube end being oppositely disposed, separated by a length;
the sight tube having an outer periphery, and at least one annular groove molded in the outer periphery inwardly spaced from each of the first sight tube end and the second sight tube end.

2. The method of claim 1 further comprising molding the sight tube possessing a tubular section defined by the length.

3. The method of claim 1 further comprising disposing a seal within each of the at least one annular groove.

4. The method of claim 1 further comprising molding a conduit, having a conduit diameter, extending the length.

5. The method of claim 4 further comprising molding the conduit substantially about a central axis of the length.

6. The method of claim 4 further comprising molding the conduit where the conduit diameter is substantially constant over the length.

7. The method of claim 1 further comprising providing at least one indicia on the sight tube.

8. The method of claim 1 further comprising molding at least one secondary annular groove in the outer periphery inwardly spaced from each of the first sight tube end and the second sight tube end.

9. The method of claim 1 further comprising molding at least one secondary annular groove inwardly spaced from the at least one annular groove wherein sectioning a middle section into lengths.

10. The method of claim 1 wherein Trogamid® is employed in molding the sight tube.
